(19) United States
(12) Patent Application Publication
(10) Pub. No.: US 2007/0088796 A1
(43) Pub. Date: Apr. 19, 2007

(54) System and method for managing console redirection at a remote information handling system

(75) Inventors: Wei Liu, Austin, TX (US); Weimin Pan, Austin, TX (US)

Correspondence Address: Roger Fulghum;Baker Botts L.L.P., One Shell Plaza, 910 Louisiana Street, Houston, TX, 77002-4995, US

(73) Assignee: DELL PRODUCTS L.P.

(21) Appl. No.: 11/252,332

(22) Filed: Oct. 17, 2005

(51) Int. Cl. G06F 15/16

(52) U.S. Cl. 709/217

(57) ABSTRACT

A system and method is disclosed for disabling selected peripheral input devices at a remote computer system during the period that the remote computer system is performing a console redirection function. When a console redirection function is initiated at a remote access card, an interrupt is issued and an interrupt handler performs a routine to disable the interface controllers that are not coupled to the remote access card of the remote computer system. Disabling the interface controllers involves configuring the interface controllers so that the controllers cannot accept input from local peripheral input devices.

### TECHNICAL FIELD

The present disclosure relates generally to computer systems and information handling systems, and, more particularly, to a system and method for filtering communications received at a network interface controller.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

In some configurations, a remote information handling system, such as a remote server computer, may be managed by another computer system, which is often referred to as a host computer. When the host computer accesses and manages the resources of the remote computer, a console redirection process occurs, allowing the console of the host computer to act as the console of the remote computer. Once console redirection occurs, the keyboard and mouse of the host computer can be used to control the operation of the remote computer.

When the host computer accesses the remote computer through a console redirection function, the host computer may access the remote computer with administrator rights, which provide the host computer with access to and the ability to access and reconfigure the most sensitive resources of the remote computer. During the period that the remote computer is being controlled by a host computer with administrative rights, the console resources of the remote computer could be accessed by an unauthorized user in the vicinity of the remote computer. If this were to occur, an unauthorized user in the vicinity of the remote computer system could access the remote computer, with administrative rights, resulting in a possible security breach in the remote computer system.

### SUMMARY

In accordance with the present disclosure, a system and method is disclosed for disabling selected peripheral input devices at a remote computer system during the period that the remote computer system is performing a console redirection function. When a console redirection function is initiated at a remote access card, an interrupt is issued and an interrupt handler performs a routine to disable certain functions of the interface controllers that are coupled to local peripheral input devices of the remote computer system. Disabling the interface controllers involves configuring the interface controllers so that the controllers cannot accept input from local peripheral input devices. When the console redirection operation is completed at the remote access card, an interrupt is issued and an interrupt handler performs a routine to enable the interface controllers.

The system and method disclosed herein is technically advantageous because it provides a method for disabling local access to a remote computer during the period that a console redirection function is being performed at the remote computer. Thus, while the remote computer system may be in administrator mode, or some other mode that allows unlimited or nearly unlimited access to the security and configuration features of the computer system, the remote computer system cannot be accessed by a local keyboard or mouse of the computer system. With the system and method disclosed herein, a console redirection function does not compromise the integrity or security of the remote computer system.

Another technical advantage of the system and method disclosed herein is that it operates in a manner that is transparent to the operation of the operating system of the remote computer system. Because the system and method disclosed herein is implemented through the use of system management interrupts, the system and method disclosed herein does not rely upon and does not involve the operation of the operating system of the remote computer system. Because the operating system of the remote computer system is not involved in the console redirection function disclosed herein, the system can be easily implemented through an interrupt handler routine. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a diagram of a remote computer system and a host computer system;

FIG. 2 is a flow diagram for disabling the local keyboard and mice resources of the remote computer upon the initiating of a console redirection function in the remote computer; and

FIG. 3 is a flow diagram for enabling the local keyboard and mice resources of the remote computer following the completion of a console redirection function in the remote computer.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

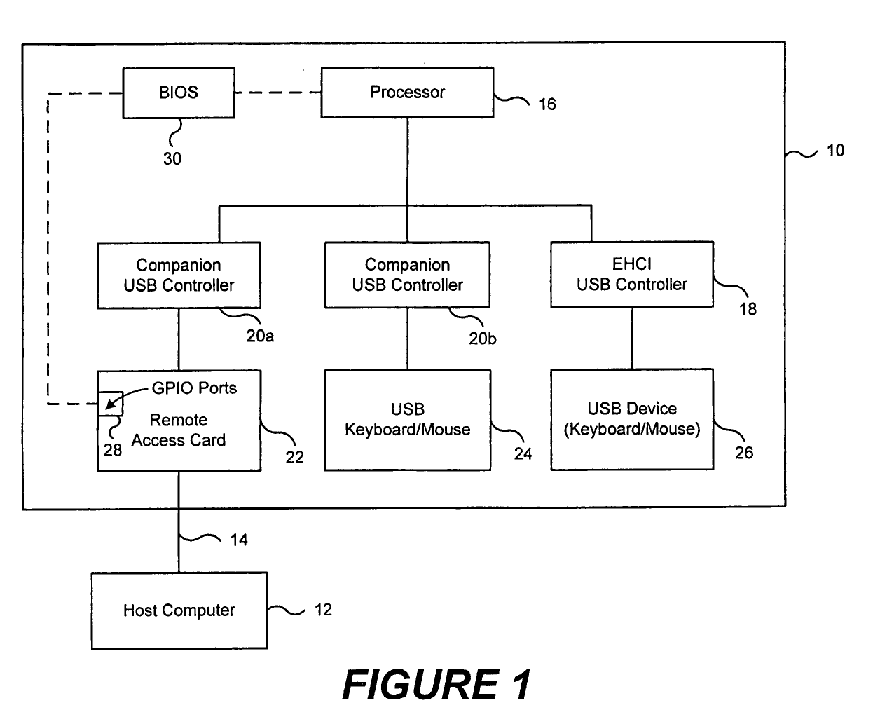

Shown in FIG. 1 is a diagram of a remote computer system 10, which is coupled to a host computer system 12. Remote computer system 12 includes a processor 16, which is communicatively coupled to a set of USB controllers. Processor 16 runs device driver software to control the operation of each of the USB controllers. In operation, the set of USB controllers includes a primary USB interface controller 18 and a number of additional companion controllers. In FIG. 1, the primary USB interface controller 18 is an Enhanced Host Controller Interface (EHCI) USB controller. Companion controllers 20 may comprise Universal Host Controller Interface (UHCI) USB controllers or Open Host Controller Interface (OHCI) USB controllers. EHCI controller 18 is coupled to higher speed USB devices, and companion controllers 20 are coupled to lower speed USB devices. In a typical configuration, the virtual keyboard and mouse of a remote access card is coupled to the first of the companion USB controllers. In this example, the virtual keyboard and mouse of remote access card 22 are coupled to companion USB controller 20a, which can be considered the first of the companion USB controllers. Although only two companion controllers are shown in FIG. 1, the architecture of the remote computer system may include multiple companion controllers.

Remote access card 22 is the interface between the host computer 12 and the remote computer 10. Remote access card 22 is an out-of-band management card that has its own processor, operating system, network interface card, and auxiliary power. Remote access card 22 can be used to initiate a console redirection function in which the input and output functions of the remote computer 12 are redirected such that the video output of the remote computer is visible at the host computer and so that the keyboard mouse input of the remote computer can be performed at the host computer.

In the example of FIG. 1, the other companion USB controller 20b is coupled to a USB port 24 for the keyboard or mouse of remote computer 10. The EHCI USB controller 18 is coupled to a high speed USB device 26. As indicated by FIG. 1, high speed USB device 26 could comprise another or the only keyboard or mouse of the remote computer 10. In operation, when a console redirection operation is initiated at the remote access card, a set of general purpose input/output ports 28 of the remote access card are set to indicate that remote computer 10 has entered a console redirection mode. Once the BIOS 30 of the remote computer 10 recognizes that the console redirection ports of the remote access card have been set, BIOS 30 initiates a system management interrupt to cause the processor to enter a system management interrupt mode an execute an interrupt handler function to disable the USB controller or controllers that control the local keyboards and mice of the remote computer.

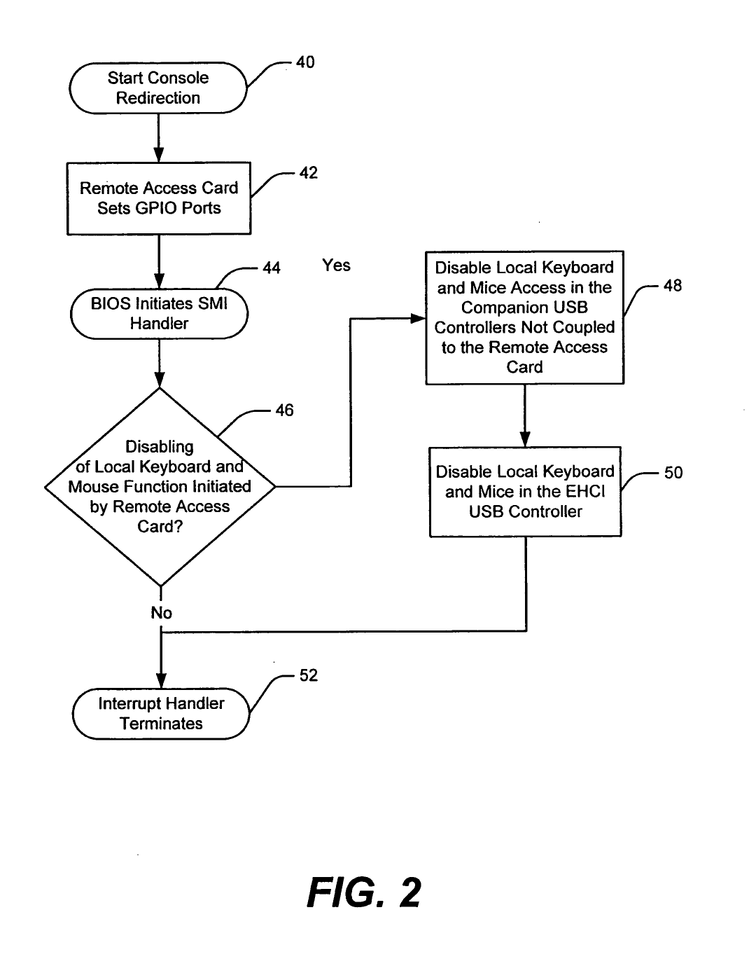

Shown in FIG. 2 is a series of method steps for disabling the local keyboard and mice resources of the remote computer upon the initiating of a console redirection function in the remote computer. At step 40, console redirection is initiated. At step to 42, remote access card 22 sets GPIO ports 28 indicate that console redirection has been initiated. At step 44, BIOS 30 issues a system management interrupt, causing processor 16 to enter a system management interrupt mode. Once in interrupt mode, processor 16 executes an interrupt routine. At step 46, the interrupt routine confirms that the disabling of the local keyboard and mouse of the remote keyboard was initiated by the remote access card. Processor 16 completes this confirmation step by reading the GPIO ports 28 of the remote access card to confirm that console redirection has been initiated at the remote access card. If the interrupt handler cannot confirm that console redirection has been initiated at the remote access card, the interrupt handler terminates at step 52. If it confirmed that console redirection has been initiated at the remote access card, the local keyboard and mice are disabled at the companion USB controllers at step 48. At step 48, local keyboard and mice access is disabled at each companion USB controller that is not coupled to remote access card of the computer system.

For UHCI USB controllers, local keyboard and mice can be disabled by the interrupt routine by clearing the Run/Stop bit in the USB command register. When this bit is set to a logical 0, the controller completes the current transaction, if any, and then halts. Once the UHCI controller halts, all devices coupled to the UHCI controller, including any keyboard or mice devices, will no longer be operable. For OHCI controllers, the PeriodicListEnable bit is cleared in the HcControl register, which will disable interrupt transactions. Keyboard and mouse devices coupled to OHCI controllers rely on interrupt transactions to accomplish transfers of data to the USB controller. When the PeriodicListEnable bit is cleared, the OHCI controller does not periodically issue an interrupt for transferring data from a keyboard or mouse, and the keyboard and mouse is no longer able to transfer data to the OHCI controller. The companion controller that is coupled to the remote access card is not disabled.

Following step 48, the local keyboard and mice are disabled in the EHCI USB controller at step 50. Any local keyboard and mice coupled to the EHCI USB controller are disabled by clearing the PeriodicScheduleEnable bit. Keyboard and mouse devices coupled to EHCI controllers rely on interrupts to accomplish transfers of data to the USB controller. When the PeriodicScheduleEnable bit is cleared, the EHCI controller does not periodically issue an interrupt for transferring data from a keyboard or mouse, and the keyboard and mouse is no longer able to transfer data to the EHCI controller. Other devices coupled to the EHCI controller that do not rely on periodic interrupts will continue to operate normally.

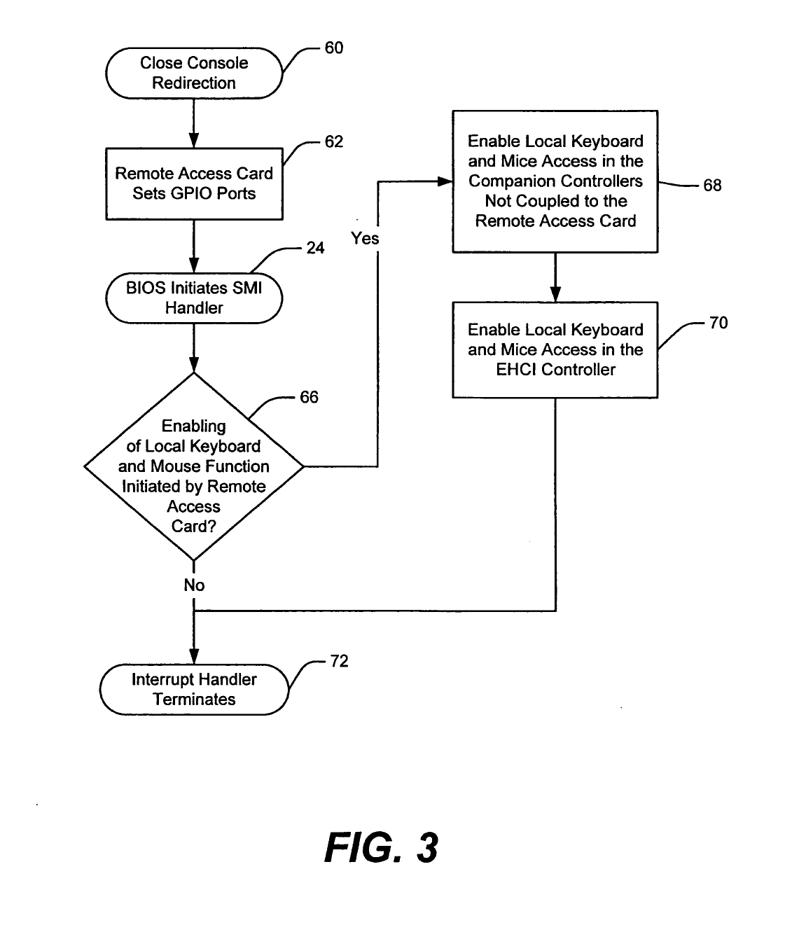

FIG. 3 is a series of method steps for enabling the local keyboard and mice resources of the remote computer following the completion of a console redirection function in the remote computer. After the user or administrator completes the console redirection function, the user will terminate the console redirection function (step 60). After the termination of the console redirection function, the remote access card at step 62 resets the GPIO ports of the remote access card to indicate that console redirection is complete. At step 64, the BIOS of the remote computer recognizes the resetting of the GPIO ports and initiates a system management interrupt, which causes the execution of an interrupt handling routine. At step 66, the interrupt handling routine reads the GPIO ports of the remote access card to confirm that console redirection has been terminated. If it is not confirmed that console redirection has been terminated, the interrupt handler terminates at step 72.

If the interrupt handler confirms that console redirection is complete, local keyboard and mice are enabled at each of the companion controllers and EHCI controllers. For UHCI companion controllers, access to local keyboard and mice are enabled at step 68 by setting the Run/Stop bit of the USB command register of the UHCI controller. For OHCI controllers, local keyboard and mice controllers are enabled by setting the PeriodicListEnable bit, which resets the periodic interrupts for the transfer of data from keyboard and mice devices. At step 68, local keyboard and mice access is enabled at each companion USB controller that is not coupled to the remote access card of the computer system. For the EHCI controller, local keyboard and mice access is enabled at step 70 by resetting the PeriodicScheduleEnable bit, which resets the periodic interrupts for the transfer of data from keyboard and mice devices.

The system described herein provides a method for disabling local access to selected peripheral input devices, such as keyboards and mice, during a period when console redirection is in effect in the remote computer system. Because the system and method disclosed herein occurs through the issuance of a system management interrupt and the operation of an interrupt handler, the method is transparent with respect to the operation of the operating system. It should be recognized that the system and method disclosed herein is not limited in its application to the precise architecture disclosed herein. Rather, the system disclosed herein can be employed in any system having a remote access card and multiple USB controllers. It should also be recognized that the system and method disclosed herein is not limited in its application to the USB controllers disclosed herein. The system and method disclosed herein may be used with any interface controller, regardless of the interface standards implemented in the device controller. Although the present disclosure has been described in detail, it should be understood that various changes, substitutions, and alterations can be made hereto without departing from the spirit and the scope of the invention as defined by the appended claims.

What is claim is:

1. A computer system, comprising:
a processor and an operating system executing thereon;
a remote access card communicatively coupled to the processor and coupled to a first interface controller; and
a second interface controller communicatively coupled to the processor and coupled to a peripheral device of the computer system;
wherein the computer system is operable to recognize when the remote access card has initiated the remote access has entered a console redirection mode and disable the second interface controller from accepting input from the peripheral device.

2. The computer system of claim 1, wherein the computer system recognizes that the remote access card by recognizing the setting of a set of general purpose input/output bits on the remote access card.

3. The computer system of claim 2, wherein the computer system disables the second interface controller from accepting input from the peripheral device by initiating an interrupt and executing the an interrupt handler routine to disable the second interface controller from accepting input from the peripheral device.

4. The computer system of claim 3, wherein the disabling of the second interface controller from accepting input from the peripheral device occurs in a manner that is transparent to the operating system of the computer system.

5. The computer system of claim 4, wherein the second interface controller is a Universal Host Interface Controller for a USB interface.

6. The computer system of claim 5, wherein the Universal Host Interface Controller is disabled by clearing the Run/Stop bit of the USB command register.

7. The computer system of claim 4, wherein the second interface controller is an Open Host Interface Controller for a USB interface.

8. The computer system of claim 5, wherein the Open Host Interface Controller is disabled by clearing the PeriodicListEnable bit in the HcControl register.

9. The computer system of claim 4, wherein the second interface controller is an Enhanced Host Interface Controller for a USB interface.

10. The computer system of claim 5, wherein the Enhanced Host Interface Controller is disabled by clearing the PeriodicScheduleEnable bit in the USB command register.

11. A method for disabling the interface controllers of a remote computer during console redirection at the remote computer, comprising:
recognizing when the remote computer has entered a console redirection mode; and
disabling an interface controller that is coupled to a peripheral input device of the computer system to prevent the interface controller from receiving input from the peripheral input device.

12. The method for disabling the interface controllers of a remote computer of claim 11, wherein the step of recognizing when the remote computer has entered a console redirection mode comprises the step of recognizing that a remote access card of the remote computer has set a set of general purpose input/output ports to signal that console redirection has been initiated at the remote access card.

13. The method for disabling the interface controllers of a remote computer of claim 12, wherein the step of disabling an interface controller comprises the step of initiating an interrupt to cause an interrupt handler to disable the interface controller that is coupled to the peripheral input device.

14. The method for disabling the interface controllers of a remote computer of claim 13, wherein the peripheral input device is a local keyboard.

15. The method for disabling the interface controllers of a remote computer of claim 13, wherein the peripheral input device is a local mouse.

16. A remote computer system, comprising:
a processor and an operating system executing thereon;
a remote access card coupled to a first interface controller;
a primary host interface controller; and
a companion host interface controller coupled to a peripheral input device;
wherein the computer system is operable to issue an interrupt to cause the processor to execute an interrupt handler routine that disables the companion host interface controller from receiving input from the peripheral input device.

17. The remote computer system of claim 16, wherein the companion host interface controller is a Universal Host Interface Controller for a USB interface and wherein the Universal Host Interface Controller is disabled by clearing the Run/Stop bit of the USB command register.

18. The remote computer system of claim 16, wherein the companion host interface controller is an Open Host Interface Controller for a USB interface and wherein the Open Host Interface Controller is disabled by clearing the PeriodicListEnable bit in the HcControl register.

19. The remote computer system of claim 16, wherein the companion host interface controller is an Enhanced Host Interface Controller for a USB interface and wherein the Enhanced Host Interface Controller is disabled by clearing the PeriodicScheduleEnable bit in the USB command register.

20. The remote computer system of claim 16, wherein the peripheral input device is a keyboard.

21. The remote computer system of claim 16, wherein the peripheral input device is a mouse.
